(19) United States
(12) Patent Application Publication
(10) Pub. No.: US 2007/0207305 A1
(43) Pub. Date: Sep. 6, 2007

(54) Panel construction for an air handling unit

(75) Inventors: Christopher A. Hord, Vancouver, WA (US); Carl J. Shell, Tigard, OR (US); David L. Lawson, Vancouver, WA (US); Chaitanya N. Bhatt, Petal, MS (US); Richard A. Thrash, Hattiesburg, MS (US)

Correspondence Address: MCNEES WALLACE & NURICK LLC, 100 PINE ST., P.O. BOX 1166, HARRISBURG, PA, 17108-1166, US

(73) Assignee: YORK INTERNATIONAL CORPORATION, York, PA (US)

(21) Appl. No.: 11/369,052

(22) Filed: Mar. 6, 2006

(51) Int. Cl. B32B 3/26

(52) U.S. Cl. 428/304.4

(57) ABSTRACT

An apparatus and method for a panel construction for an air handling unit includes a first skin and a second skin. A plurality of members is disposed between the first and second skin to separate the first and second skin. Each member of the plurality of members is connectable to one or both the first and second skins and includes at least one structural member and at least one thermal break. The at least one structural member and the at least one thermal break are configured and disposed to prevent a continuous path of substantially reduced thermal insulative properties between the first and second skin.

### FIELD OF THE INVENTION

The present invention is directed to wall constructions for air handling units, and more particularly, to a wall construction for an air handling unit having improved thermal insulative properties.

### BACKGROUND OF THE INVENTION

Air Handling Units (AHUs) are one of several components in cooling and heating systems. They are an important component because the AHU houses a number of components used in the system to provide forced air for climate control in a particular structure. AHU components typically include motors, heating/cooling coils, and blowers as well as the required interface connections to affect such climate control.

The AHU is an enclosed interconnected framed panel structure. The framed panel structure includes substantially thermally insulated panels that are supported between framing members, to define interconnected rectangular compartments. Although the panels are substantially thermally insulated, structural members are typically disposed between opposed skins to enhance the structural strength properties of the panel. Typically, the structural members and opposed skins, which are of metal construction, are secured together by metal screws. Therefore, despite the addition of insulating material between the skins, there is an amount of metal-to-metal contact between the opposed skins, which provides a continuous path of substantially reduced thermal insulative properties between the opposed skins. This reduction of thermal insulative properties adversely affects the efficiency of the cooling and heating system.

What is needed is an improved panel construction that does not include a continuous path of substantially reduced thermal insulative properties between the opposed skins of the panel.

### SUMMARY OF THE INVENTION

The present invention relates to a panel construction for an air handling unit including a first skin and a second skin. A plurality of members is disposed between the first and second skin to separate the first and second skin. Each member of the plurality of members is connectable to one or both the first and second skins and includes at least one structural member and at least one thermal break. The at least one structural member and the at least one thermal break are configured and disposed to prevent a continuous path of substantially reduced thermal insulative properties between the first and second skin.

The present invention further relates to a panel construction for an air handling unit including a first metal skin and a second metal skin. A plurality of members are disposed between the first and second skin to separate the first and second skin. Each member of the plurality of members are connectable to one or both the first and second skins and include at least one structural member and at least one thermal break. The at least one structural member and the at least one thermal break are configured and disposed to prevent a continuous metal-to-metal contact between the first and second skin.

The present invention still further relates to a method of constructing a panel for an air handling unit. The method includes the step of assembling a plurality of members, each member of the plurality of members including at least one metal structural member and at least one thermal break. The at least one structural member and the at least one thermal break are configured and disposed to form opposed surfaces, there being an absence of a continuous path of substantially reduced thermal insulative properties between the opposed surfaces. The method further includes connecting a first skin to one surface and connecting a second skin to the surface opposite the one surface. The method further includes injecting an insulating material between the first and second skin.

An advantage of the present invention is that it provides improved thermal insulative properties for air handling unit panels.

A further advantage of the present invention is that the number of parts is reduced.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective cutaway view of a panel of the present invention.

FIG. 2 is a partial cross section of a framework member taken along line 1-1 from FIG. 1 of a panel of the present invention.

FIG. 3 is a partial cross section of a framework member taken along line 2-2 from FIG. 1 of an assembled panel of the present invention.

FIG. 4 is a partial cross section of an alternate embodiment of a framework member taken along line 1-1 from FIG. 1 of a panel of the present invention.

FIG. 5 is a partial cross section of an alternate embodiment of a framework member taken along line 2-2 from FIG. 1 of an assembled panel of the present invention.

FIG. 6 is a partial cross section of an alternate embodiment of a framework member taken along line 1-1 from FIG. 1 of a panel of the present invention.

FIG. 7 is a partial cross section of an alternate embodiment of a framework member taken along line 2-2 from FIG. 1 of an assembled panel of the present invention.

FIG. 8 is a partial cross section of an alternate embodiment of a framework member taken along line 1-1 from FIG. 1 of a panel of the present invention.

FIG. 9 is a partial cross section of an alternate embodiment of a framework member taken along line 2-2 from FIG. 1 of an assembled panel of the present invention.

FIG. 10 is a partial cross section of an alternate embodiment of a framework member taken along line 1-1 from FIG. 1 of a panel of the present invention.

FIG. 11 is a partial cross section of an alternate embodiment of a framework member taken along line 2-2 from FIG. 1 of an assembled panel of the present invention.

FIG. 12 is a partial cross section of an alternate embodiment of a framework member taken along line 2-2 from FIG. 1 of an assembled panel of the present invention.

FIG. 13 is an exploded partial perspective view of a panel framework of the present invention.

FIG. 14 is a partial cross section of an alternate embodiment of a panel framework member taken along line 2-2 from FIG. 1 of an assembled panel of the present invention.

FIG. 15 is a partial cross section of an alternate embodiment of a pair of panel frameworks forming a corner of an AHU of the present invention.

FIG. 16 is a partial cross section of an alternate embodiment of a pair of panel frameworks forming a butt joint of the present invention.

FIG. 17 is a partial cross section of an alternate embodiment of a pair of panel frameworks defining a peripheral roof joint for an AHU of the present invention.

Wherever possible, the same reference numbers will be used throughout the drawings to refer to the same or like parts.

### DETAILED DESCRIPTION OF THE INVENTION

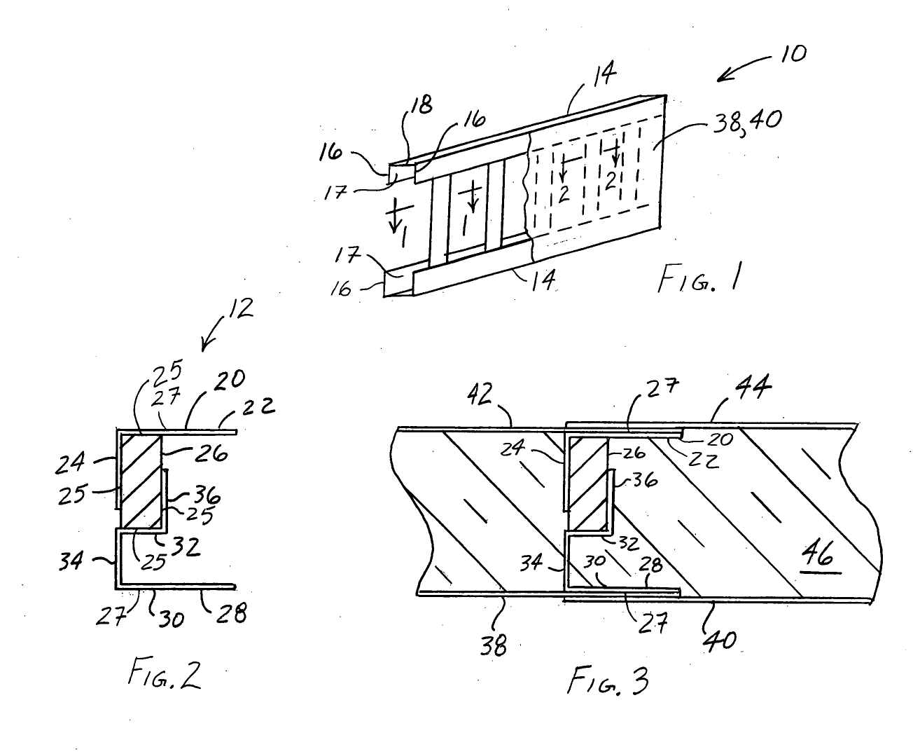

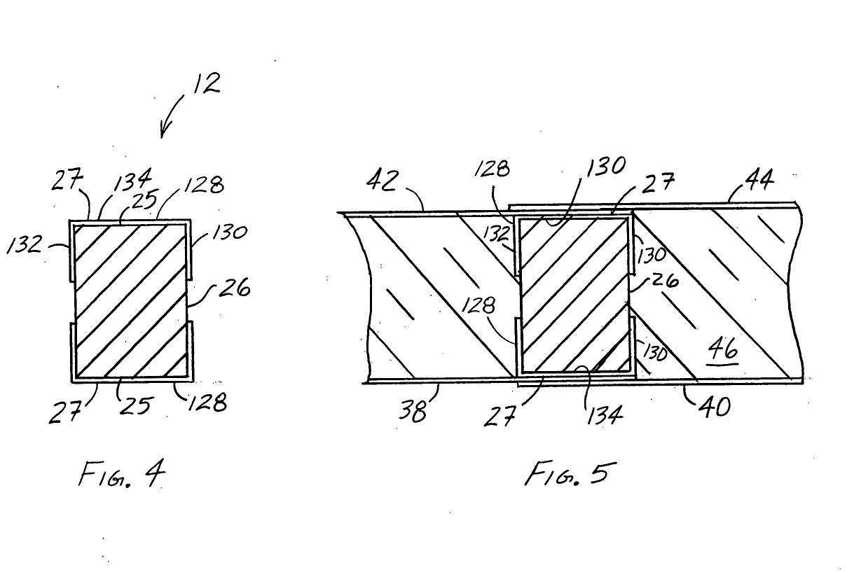

One embodiment of a panel framework 10 of the present invention is depicted in FIG. 1. Preferably, referring to FIGS. 2-3, the panel framework 10 includes a plurality of posts or members 12 that are spaced apart from each other to provide structural stiffness and strength. To form the panel framework 10, the ends of each member 12 is directed into a channel 17 formed in respective C-channels 14. Channel 17 is defined by a web 18 disposed between opposed legs 16 of C-channel 14. Once the panel framework 10 is assembled, skins 42, 44 are secured to one side of member 12 and skins 38, 40 are secured to the other side of member 12 to form a panel. Preferably, adjacent skins 38, 40 on one side of member 12 and adjacent skins 42, 44 on the other side of member 12 slightly overlap to provide a continuous skin surrounding the framework 10. As will be discussed in further detail below, the plurality of members 12 that are connected to opposed skins 38, 42 and 40, 44 lack a continuous path of substantially reduced thermal insulative properties between the first and second skin.

As shown in FIGS. 2 and 3, member 12 includes an angle 20 and a support member 28. Preferably, angle 20 and support member 28 are constructed of metal sheet for enhanced strength. Angle 20 includes a pair of legs 22, 24 preferably disposed substantially perpendicular to each other. Support member 28 resembles a C-channel in that leg 30 and leg 32 are preferably substantially parallel to each other and each leg 30, 32 is secured to an opposite end of a web 34. Extending from an end of leg 32 opposite of the web 34 is a flange 36 that is substantially parallel to web 34. Preferably, a continuous length of thermal break or insulating material 26 having an amount of structural strength and rigidity, such as a rectangular bar of a polymer or dense plastic, is disposed between angle 20 and support member 28 so that no portion of angle 20 is in direct contact with support member 28.

Insulating material 26 can also be constructed of acrylonitrile butadiene styrene (ABS), polyvinyl chloride (PVC), LEXAN®, a registered trademark owned by General Electric Company, or other suitable material. Additionally, although the insulating material 26 can be of solid construction, hollow construction can also be used to save weight and material cost. Furthermore, in cases where the cross sectional dimensions are sufficiently increased in a direction that is transverse to the parallel skins and/or the aspect ratio of the insulating material 26 approaches 1, the insulating material 26 can also be polyiso board. Polyiso board is typically constructed of polyurethane material and has a density of between about 2 to about 6 pounds per cubic foot. However, it is to be understood that a thermal break or insulating material 26 can also be discontinuous, so long as spacing is maintained between angle 20 and support member 28. As further shown in FIGS. 2-3, one corner of the insulating material 26 is directed toward the junction between legs 22, 24, and the opposite corner of the insulating material 26 is directed toward the junction between leg 32 and flange 36. By maintaining spacing between angle 20 and support member 28 due to the insulating material 26, a path of substantially reduced thermal insulative properties cannot extend between angle 20 and support member 28. To secure the insulating material 26, preferably an adhesive 25 is applied between the insulating material 26 and the contacting surfaces of legs 22, 24 of the angle 20 and leg 32 and flange 36 of the support member 28. Other fastening devices or means, including, but not limited to, screws, nails, nuts and bolts, clamps and the like can be used by themselves or in combination with the adhesive 25 to secure the insulating material 26 to the angle 20 and support member 28. However, adhesive 25 is preferred, as it can be applied to the insulating material 26 to reduce assembly time.

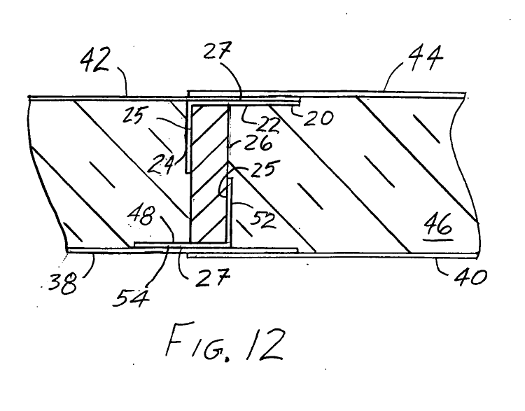

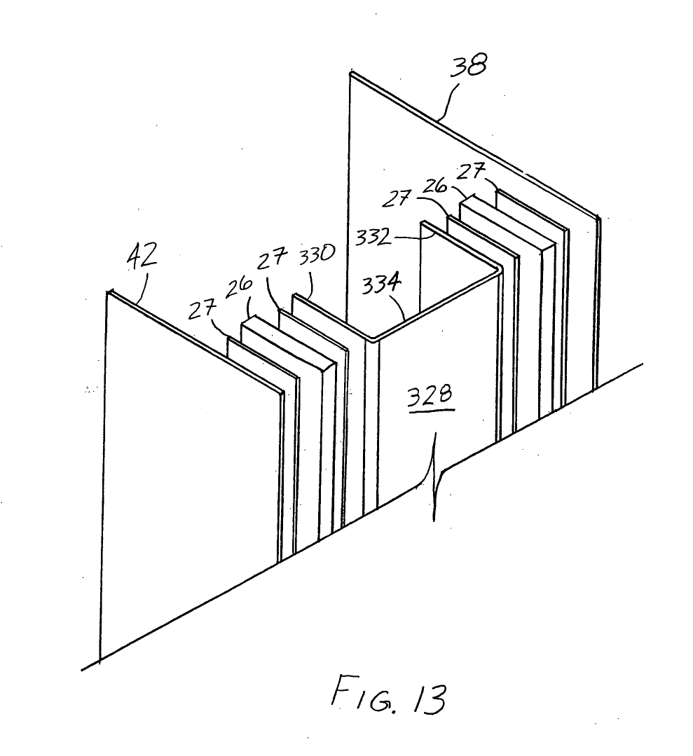

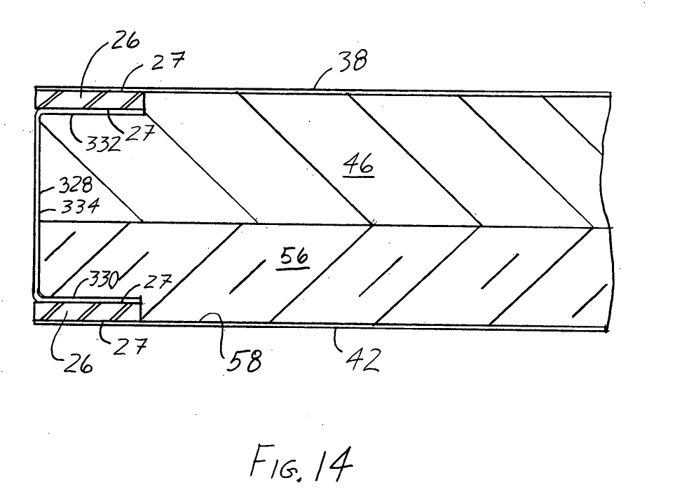

As shown in FIG. 12, member 12 includes angle 20 and angle 48. Preferably, angle 20 and angle 48 are constructed of metal sheet for enhanced strength. Angle 20 includes a pair of legs 22, 24 preferably disposed approximately perpendicular to each other. Angle 48 includes a pair of legs 52, 54 preferably disposed approximately perpendicular to each other. Preferably a continuous length of insulating material 26 having an amount of structural strength and rigidity, as previously discussed, is disposed between angle 20 and angle 48 so that no portion of angle 20 is in direct contact with angle 48. However, it is to be understood that an insulating material 26 can also be discontinuous, e.g., multiple segments, so long as spacing is maintained between angle 20 and angle 48. As further shown in FIG. 12, one corner of the insulating material 26 is directed toward the junction between legs 22, 24, and the opposite corner of the insulating material 26 is directed toward the junction between legs 48, 52. By maintaining spacing between angle 20 and angle 48 due to the insulating material 26, a path of substantially reduced thermal insulative properties cannot extend between angle 20 and angle 48. To secure the insulating material 26, preferably an adhesive 25 is applied between the insulating material 26 and the contacting surfaces of legs 22, 24 of angle 20 and legs 48, 52 of angle 48. Other fastening means, including, but not limited to, screws, nails, nuts and bolts, clamps and the like can be used by themselves or in combination with the adhesive 25 to secure the insulating material 26 to the angle 20 and support member 28. However, adhesive 25 is preferred, as it can be applied to the insulating material 26 to reduce assembly time. It is to be understood that adhesive 25 can be provided in the form of a tape including opposed surfaces which additionally have a layer of adhesive applied to each of the opposed surfaces.

As discussed above, devices or means other than adhesives 25 can be used by themselves or in combination with the adhesive 25 to secure the insulating material 26 to angle 20 and support member 28, so long as a fastening device that conducts thermal energy does not directly connect angle 20 and support member 28. For example, if the fastening device is a metal screw, metal being a thermal conductor, the screw can extend through one or both of legs 22, 24 of angle 20, but cannot extend through and additionally contact any portion of support member 28. Such direct contact between angle 20 and support member 28 establishes a path of substantially reduced thermal insulative properties between angle 20 and support member 28. This path undesirably reduces the thermal efficiency of the panel. Similarly, if the adhesive 25 used sufficiently conducts thermal energy and is applied to the insulating material 26 so that a path of substantially reduced thermal insulative properties exists between angle 20 and support member 28 when assembled to the insulating material 26, a discontinuity in the application of the adhesive 25 must be provided. Such discontinuity prevents the formation of an undesired path of substantially reduced thermal insulative properties.

It is also to be understood that a path of substantially reduced thermal insulative properties is also to be avoided for each of the subsequently mentioned member 12 constructions.

Once the insulating material 26 and the angle 20 and support member 28 have been assembled to form members 12, and the members 12 have been assembled to form the panel framework 10, skins 38, 42 can then be assembled to respective sides of the members 12 to form an insulated panel. That is, as shown in FIG. 3, skin 38 is brought into contact with leg 30 of support member 28. At this point, skin 38 is free to move with respect to leg 30. Once skin 38 is properly positioned with respect to support member 28, leg 30 is preferably secured to skin 38 by a layer of tape 27 having an adhesive layer applied to each opposed surface of the tape 27. In one embodiment, the tape 27 is secured to the surface of leg 30 facing away from web 34 prior to bringing the skin 38 into contact with the leg 30. As further shown in FIG. 3, skin 40 overlaps a portion of skin 38. Skin 40 can be separate from skin 38 and secured to skin 38, such as by tape 27 or other securing means known in the art, including, but not limited to, an adhesive, welding or mechanical fasteners. Alternately, skins 38, 40 can be preassembled together, such as by any of the methods previously discussed, prior to bringing the skins 38, 40 into contact with the tape 27. Tape 27 or other securing means or device may have thermal insulative properties that are sufficient to provide an adequate thermal break. However, in a preferred embodiment, tape 27 comprises a foam layer, preferably of a closed cell construction, such as a polyiso material previously discussed, that resists compression when disposed between adjacent surfaces. Use of a foam layer tape provides superior thermal insulative properties that is sufficient to prevent a path of substantially reduced thermal insulative properties from occurring in the panel.

After skins 38, 40 have been secured to leg 30, skin 42, or preassembled skins 42, 44 as previously discussed, is brought into contact with leg 22 of angle 20. Skin 42 is free to move with respect to leg 22. Once skin 42 is properly positioned with respect to leg 22, leg 22 is preferably secured to skin 42 by a layer of tape 27 having an adhesive layer applied to each opposed surface of the tape 27. In one embodiment, the tape 27 is secured to the surface of leg 22 facing away from leg 24 prior to bringing the skin 42 into contact with the leg 22. As shown in FIG. 3, skin 44 overlaps a portion of skin 42. Skin 44 can be separate from skin 42 and secured to skin 42, such as by tape 27 or other securing means known in the art, including, but not limited to, welding or mechanical fasteners. Alternately, skins 42, 44 can be preassembled together, such as by any of the methods previously discussed, prior to bringing the skins 42, 44 into contact with the tape 27. Once skins 42, 44 are assembled, insulating material 46, such as previously discussed, is injected inside the panel to provide enhanced insulative properties and structural strength and rigidity. Additionally, by virtue of injecting the insulating material 46 under carefully controlled conditions, the insulating material 46 occupies virtually all of the space between the skins 42, 44 not already in position, such as the member(s) 12. In other words, voids or air pockets are substantially eliminated, resulting in a panel construction that is virtually fluid tight, eliminating convective air streams that can otherwise flow in either direction from between the skins to the outside environment during use. Such convective airflow can result in the formation of condensation, resulting in water damage, corrosion, the formation of mold or mildew, or other undesirable effects. An additional benefit

It is to be understood that the tape 27 can be first secured to either skin 38, 42 or to leg 30 or leg 22.

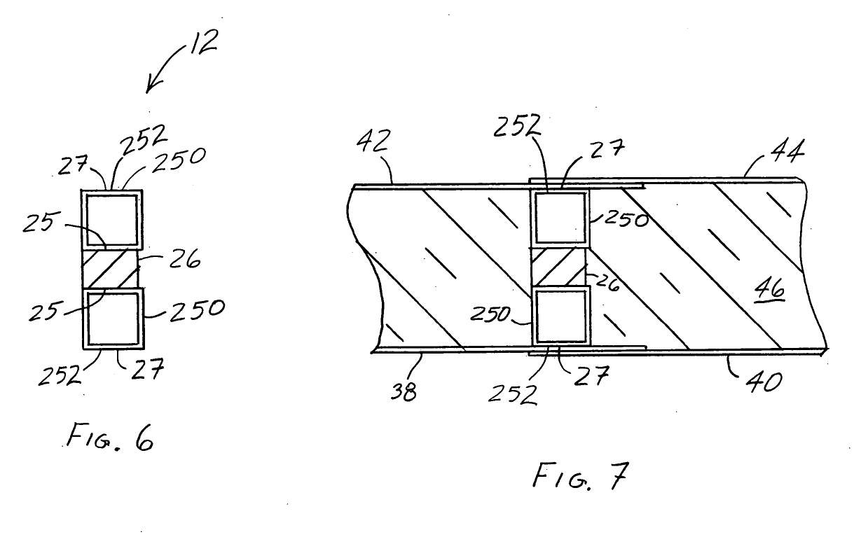

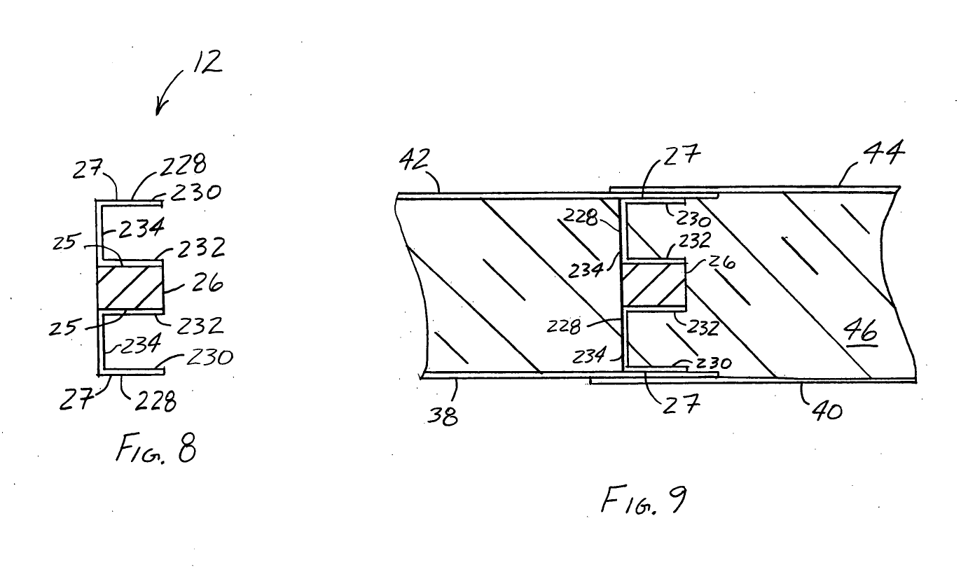

As shown in FIGS. 4-5, member 12 includes a pair of opposed support members 128, each support member 128 including a pair of opposed, substantially parallel legs 130, 132 separated by a web 134. Preferably, the support members 128 are constructed of metal sheet for enhanced strength. Preferably, a continuous length of insulating material 26 having a sufficient amount of structural strength and rigidity, as previously discussed, is disposed between the opposed support members 128 so that no portion of the support members 128 are in direct contact. However, it is to be understood that the insulating material 26 can also be discontinuous, so long as a spacing is maintained between support members 128. Each end of the insulating material 26 is directed into a channel of each support member 128 defined by legs 130, 132 and web 134. By maintaining spacing between the support members 128 due to the insulating material 26, a path of substantially reduced thermal insulative properties cannot extend between the support members 128. To secure the insulating material 26, preferably an adhesive 25 is applied between the contacting surfaces of legs 130, 132, web 134 and the insulating material 26. Other fastening means, including, but not limited to, screws, nails, nuts and bolts, clamps and the like can be used by themselves or in combination with the adhesive 25 to secure the insulating material 26 to the support members 128 so long as a path of a substantially reduced thermal insulative properties is not formed, as previously discussed. However, adhesive 25 is preferred, as it can be applied to the insulating material 26 to reduce assembly time.

Once the insulating material 26 and the support members 128 have been assembled to form members 12, and the members 12 have been assembled to form the panel framework 10, skins 38, 42 can then be assembled to respective opposed sides of the members 12 to form an insulated panel. That is, as shown in FIG. 5, skin 38 is brought into contact with web 134 of support member 128. At this point, skin 38 is free to move with respect to web 134. Once skin 38 is properly positioned with respect to support member 128, web 134 is preferably secured to skin 38 by a layer of tape 27 having an adhesive applied to each opposed surface of the tape 27. In one embodiment, the tape 27 is secured to the surface of web 134 facing away from leg 130 prior to bringing the skin 38 into contact with the web 134. As further shown in FIG. 5, skin 40 overlaps a portion of skin 38. Skin 40 can be separate from skin 38 and secured to skin 38, such as by tape 27 or other securing means known in the art, including, but not limited to, adhesives, welding or mechanical fasteners. Alternately, skins 38, 40 can be preassembled together, such as by any of the methods previously discussed, prior to bringing the skins 38, 40 into contact with the tape 27.

After skins 38, 40 have been secured to web 134, skin 42, or preassembled skins 42, 44, as previously discussed, is brought into contact with web 134 of the other support member 128. Skin 42 is free to move with respect to web 134. Once skin 42 is properly positioned with respect to web 134, web 134 is preferably secured to skin 42 by a layer of tape 27 having an adhesive layer applied to each opposed surface of the tape 27. In one embodiment, the tape 27 is secured to the surface of web 134 facing away from leg 130 prior to bringing the skin 42 into contact with the web 134. As further shown in FIG. 5, skin 44 overlaps a portion of skin 42. Skin 44 can be separate from skin 42 and secured to skin 42, such as by tape 27 or other securing means known in the art, including, but not limited to, welding or mechanical fasteners. Alternately, skins 42, 44 can be preassembled together, such as by any of the methods previously discussed, prior to bringing the skins 42, 44 into contact with the tape 27. Once skins 42, 44 are assembled, insulating material 46, such as previously discussed, is injected inside the panel to provide enhanced insulative properties and structural strength and rigidity.

It is to be understood that the tape 27 can be first secured to either skin 38, 42 or to leg 30 or leg 22.

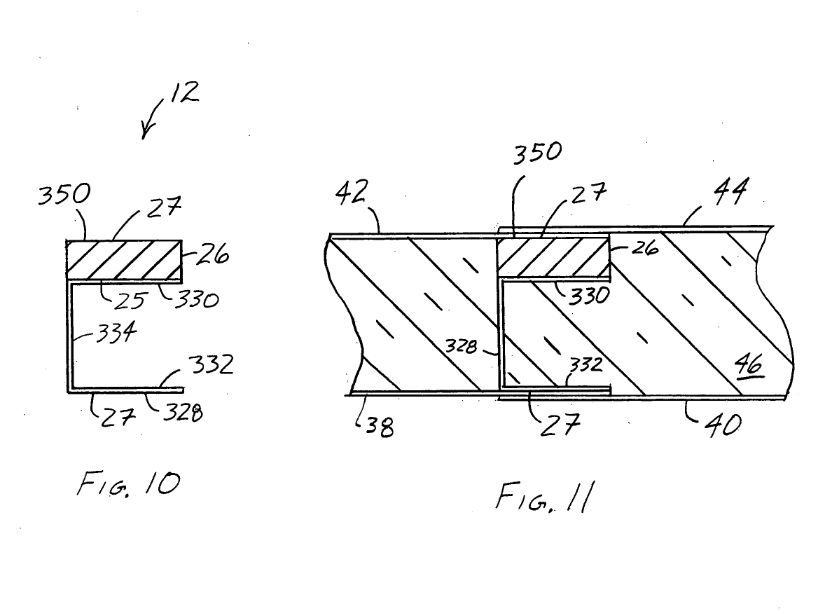

As shown in FIGS. 6-7, member 12 includes a pair of opposed tubes 250, each tube 250 including two opposed pairs of interconnected sides. Preferably, the tubes 250 are constructed of metal sheet for enhanced strength. Preferably, a continuous length of insulating material 26 having a sufficient amount of structural strength and rigidity, as previously discussed, is disposed between the opposed tubes 250 so that no portion of the tubes 250 are in direct contact. However, it is to be understood that the insulating material 26 can also be discontinuous, so long as a spacing is maintained between tubes 250. Opposed ends of the insulating material 26 are each directed into abutting contact with one side of one tube 250. By maintaining spacing between the tubes 250 due to the insulating material 26, a path of substantially reduced thermal insulative properties cannot extend between the tubes 250. To secure the insulating material 26, preferably an adhesive 25 is applied between the contacting surfaces of the sides of tubes 250 and the insulating material 26. Other fastening means, including, but not limited to, screws, nails, nuts and bolts, clamps and the like can be used by themselves or in combination with the adhesive 25 to secure the insulating material 26 to the tubes 250 so long as a path of substantially reduced thermal insulative properties is not formed, as previously discussed. However, adhesive 25 is preferred, as it can be applied to the insulating material 26 to reduce assembly time.

Once the insulating material 26 and the tubes 250 have been assembled to form members 12, and the members 12 have been assembled to form the panel framework 10, skins 38, 42 can then be assembled to respective sides of the members 12 to form an insulated panel. That is, as shown in FIG. 7, skin 38 is brought into contact with a side 252 of tube 250. At this point, skin 38 is free to move with respect to tube 250. Once skin 38 is properly positioned with respect to tube 250, side 252 is preferably secured to skin 38 by a layer of tape 27 having an adhesive applied to each opposed surface of the tape 27. In one embodiment, the tape 27 is secured to side 252 prior to bringing the skin 38 into contact with surface 252. As further shown in FIG. 7, skin 40 overlaps a portion of skin 38. Skin 40 can be separate from skin 38 and secured to skin 38, such as by tape 27 or other securing means known in the art, including, but not limited to, adhesives, welding or mechanical fasteners. Alternately, skins 38, 40 can be preassembled together, such as by any of the methods previously discussed, prior to bringing the skins 38, 40 into contact with the tape 27.

After skins 38, 40 have been secured to side 252 of one tube 250, skin 42, or preassembled skins 42, 44, as previously discussed, is brought into contact with side 252 of the other tube 250. Skin 42 is free to move with respect to tube 250. Once skin 42 is properly positioned with respect to side 252, side 252 is preferably secured to skin 42 by a layer of tape 27 having an adhesive layer applied to each opposed surface of the tape 27. In one embodiment, the tape 27 is secured to side 252 prior to bringing the skin 42 into contact with side 252. As further shown in FIG. 7, skin 44 overlaps a portion of skin 42. Skin 44 can be separate from skin 42 and secured to skin 42, such as by tape 27 or other securing means known in the art, including, but not limited to, welding or mechanical fasteners. Alternately, skins 42, 44 can be preassembled together, such as by any of the methods previously discussed, prior to bringing the skins 42, 44 into contact with the tape 27. Once skins 42, 44 are assembled, insulating material 46, as previously discussed, is injected inside the panel to provide enhanced insulative properties and structural strength and rigidity.

It is to be understood that the tape 27 can be first secured to either skin 38, 42 or to either side 252 of tube 250.

As shown in FIGS. 8-9, member 12 includes a pair of opposed support members 228, each support member 228 including two opposed legs 228, 230 separated by and maintained in a substantially parallel position by a web 234. Preferably, the support members 228 are constructed of metal sheet for enhanced strength. Preferably, a continuous length of insulating material 26 having a sufficient amount of structural strength and rigidity, as previously discussed, is disposed between the opposed support members 228 so that no portion of the support members 228 are in direct contact. However, it is to be understood that the insulating material 26 can also be discontinuous so long as a spacing is maintained between support members 228. Each opposed end of the insulating material 26 is directed into abutting contact with side 232 of one support member 228. By maintaining spacing between support members 228 due to the insulating material 26, a path of substantially reduced thermal insulative properties cannot extend between the support members 228. To secure the insulating material 26, preferably an adhesive 25 is applied between each side 232 of support members 228 and the insulating material 26. Other fastening means, including, but not limited to, screws, nails, nuts and bolts, clamps and the like can be used by themselves or in combination with the adhesive 25 to secure the insulating material 26 to the support members 228. However, adhesive 25 is preferred, as it can be applied to the insulating material 26 to reduce assembly time. It is appreciated by those having skill in the art that the orientation of the legs 230, 232 of one support member 228 can face in the same or opposite horizontal direction and that the legs 230, 232 of either or both support members 228 can extend in the same or opposite directions as shown in FIGS. 8-9.

Once the insulating material 26 and the support members 228 have been assembled to form members 12, and the members 12 have been assembled to form the panel framework 10, skins 38, 42 can then be assembled to respective sides of the members 12 to form an insulated panel. That is, as shown in FIG. 9, skin 38 is brought into contact with leg 230 of support member 228. At this point, skin 38 is free to move with respect to support member 228. Once skin 38 is properly positioned with respect to support member 228, leg 230 is preferably secured to skin 38 by a layer of tape 27 having an adhesive applied to each opposed surface of the tape 27. In one embodiment, the tape 27 is secured to leg 230 prior to bringing the skin 38 into contact with leg 230. As further shown in FIG. 9, skin 40 overlaps a portion of skin 38. Skin 40 can be separate from skin 38 and secured to skin 38, such as by tape 27 or other securing means known in the art, including, but not limited to, adhesives, welding or mechanical fasteners. Alternately, skins 38, 40 can be preassembled together, such as by any of the methods previously discussed, prior to bringing the skins 38, 40 into contact with the tape 27.

After skins 38, 40 have been secured to leg 230, skin 42, or preassembled skins 42, 44, as previously discussed, is brought into contact with leg 230 of the other support member 228. Skin 42 is free to move with respect to leg 230. Once skin 42 is properly positioned with respect to leg 230, leg 230 is preferably secured to skin 42 by a layer of tape 27 having an adhesive layer applied to each opposed surface of the tape 27. In one embodiment, the tape 27 is secured to leg 230 prior to bringing the skin 42 into contact with leg 230. As further shown in FIG. 9, skin 44 overlaps a portion of skin 42. Skin 44 can be separate from skin 42 and secured to skin 42, such as by tape 27 or other securing means known in the art, including, but not limited to, welding or mechanical fasteners. Alternately, skins 42, 44 can be preassembled together, such as by any of the methods previously discussed, prior to bringing the skins 42, 44 into contact with the tape 27. Once skins 42, 44 are assembled, insulating material 46, as previously discussed, is injected inside the panel to provide enhanced insulative properties and structural strength and rigidity.

It is to be understood that the tape 27 can be first secured to either skin 38, 42 or to either leg 230 of support member 228.

As shown in FIGS. 10-11, member 12 includes a single support member 328, such as a C-channel, including two opposed legs 328, 330 separated by and maintained in a substantially parallel position by a web 334. Alternatively, the legs 328, 330 can extend in the opposite horizontal direction than as shown in FIGS. 10-11. Preferably, the support member 328 is constructed of metal sheet for enhanced strength. Preferably, a continuous length of insulating material 26 having a sufficient amount of structural strength and rigidity, as previously discussed, is secured to leg 330. That is, preferably the bar of insulating material 26 has opposed ends, one end of the insulating material 26 being directed into abutting contact with leg 330 and an opposed end 350 of the insulating material 26 facing away from support member 328. However, it is to be understood that the insulating material 26 can also be discontinuous. To secure the insulating material 26 to support member 328, preferably an adhesive 25 is applied between side 330 of support member 328 and the insulating material 26. Other fastening means, including, but not limited to, screws, nails, nuts and bolts, clamps can be used by themselves or in combination with the adhesive 25 to secure the insulating material 26 to the support member 328. However, adhesive 25 is preferred, as it can be applied to the insulating material 26 to reduce assembly time.

Once the insulating material 26 and the support members 328 have been assembled to form members 12, and the members 12 have been assembled to form the panel framework 10, skins 38, 42 can then be assembled to respective sides of the members 12 to form an insulated panel. That is, as shown in FIG. 11, skin 38 is brought into contact with leg 332 of support member 328. At this point, skin 38 is free to move with respect to support member 328. Once skin 38 is properly positioned with respect to support member 328, leg 332 is preferably secured to skin 38 by a layer of tape 27 having an adhesive applied to each opposed surface of the tape 27. In one embodiment, the tape 27 is secured to leg 332 prior to bringing the skin 38 into contact with leg 332. As further shown in FIG. 11, skin 40 overlaps a portion of skin 38. Skin 40 can be separate from skin 38 and secured to skin 38, such as by tape 27 or other securing means known in the art, including, but not limited to, adhesives, welding or mechanical fasteners. Alternately, skins 38, 40 can be preassembled together, such as by any of the methods previously discussed, prior to bringing the skins 38, 40 into contact with the tape 27.

After skins 38, 40 have been secured to leg 332, skin 42, or preassembled skins 42, 44, as previously discussed, is brought into contact with end 350 of the insulating material 26. Skin 42 is free to move with respect to end 350. Once skin 42 is properly positioned with respect to end 350, end 350 is preferably secured to skin 42 by a layer of tape 27 having an adhesive layer applied to each opposed surface of the tape 27. In one embodiment, the tape 27 is secured to end 350 prior to bringing the skin 42 into contact with end 350. As further shown in FIG. 11, skin 44 overlaps a portion of skin 42. Skin 44 can be separate from skin 42 and secured to skin 42, such as by tape 27 or other securing means known in the art, including, but not limited to, welding or mechanical fasteners. Alternately, skins 42, 44 can be preassembled together, such as by any of the methods previously discussed, prior to bringing the skins 42, 44 into contact with the tape 27. Once skins 42, 44 are assembled, insulating material 46, as previously discussed, is injected inside the panel to provide enhanced insulative properties and structural strength and rigidity.

One skilled in the art can appreciate that upon installation of member 12 between skins 38, 42, a spacing is maintained between the support member 328 and skin 42 due to the insulating material 26. In other words, by virtue of this spacing between support member 328 and skin 42, a path of substantially reduced thermal insulative properties cannot extend between the skins 38, 42.

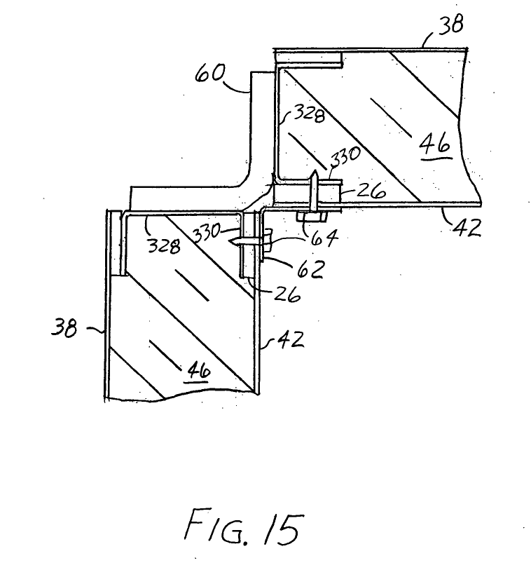

An alternate embodiment of panel framework 10 of the present invention is shown by FIG. 13 including structural member 328 including web 334 that is disposed between opposed legs 330, 332. Each surface of the legs 330, 332 facing away from the structural member 328 is preferably secured to one surface of insulating material 26, with the opposite surfaces of the insulating material secured to skins 38, 42. Preferably, tape 27, which includes opposed surfaces having a layer of adhesive applied to each tape surface, is used to secure the connections between the facing surfaces of the skins 38, 42, insulating material 26 and structural member legs 330, 332. Preferably, structural member 328, insulating material 26 and skins 38, 42 can be pre-assembled without exposing their facing surfaces to both exposed adhesive surfaces of any of the segments of tape 27. That is, tape 27 includes a carrier layer (not shown) that is applied over each adhesive surface to prevent the tape which is provided on a roll from adhering to itself. It is to be understood that other structural member constructions can be used so long as the structural member includes opposed surfaces for connection with the skins 38, 42 and at least one layer of insulating material 26 separating skins 38, 42.

It is to be understood that the insulating material 26 may also be continuous or discontinuous, as previously discussed.

Preferably, one carrier layer is removed from tape 27, exposing one adhesive surface that is applied to one of the facing surfaces of legs 330, 332 of the corresponding structural member 328, insulating material 26 and skins 38, 42. While the exposed adhesive surface of tape 27 bonds to a corresponding facing surface of the structural member 328, insulating material 26 and skins 38, 42, the carrier layer to the opposed side of the tape remains in place, allowing relative movement between the surfaces of the structural member, insulating material and skins in contact with the carrier layer. In other words, although one surface of tape 27 may adhere to skin 38, the opposite surface of tape 27, which is covered by the carrier layer, permits relative movement between the facing surface of insulating material 26. Similarly, this relative movement occurs between each pair of facing surfaces of the preassembled panel framework 10 (i.e., legs 330, 332, insulating material 26 and skins 38, 42) in which only one adhesive surface of tape 27 is exposed. Upon the satisfactory positioning of the structural member 328, insulating material 26 and skins 38, 42, the carrier layers of each of the tapes 27 can be removed, permitting the respective structural member 328, insulating material 26 and skins 38, 42 of panel framework to be connected to each other. An insulating material or thermal break is then preferably injected between the skins 38, 42 of the assembled panel framework 10, as previously discussed.

In the configuration shown in FIG. 13, legs 330, 332 are connectable to one surface of insulating material 26 and the other surface of insulating material 26 is connectable to one surface of legs 330, 332 or to one surface of skins 38, 42. However, if desired, only one insulating material 26 is required to practice the present invention, in that there is no continuous path of substantially reduced thermal insulative properties between skins 38, 42.

It is to be understood that it may be desirable to use any sequence of removal of the carrier layers of tapes 27 to effect assembly of the panel framework 10. For example, one surface of tape 27 can be adhered to leg 332 of structural member 328, followed immediately by adhering one surface of insulating material 26 to the opposite surface of tape 27 prior to preassembling the remaining components.

It is to be understood that structural member 328 can be discontinuous so that insulating material 26 can extend between skins 38, 42.

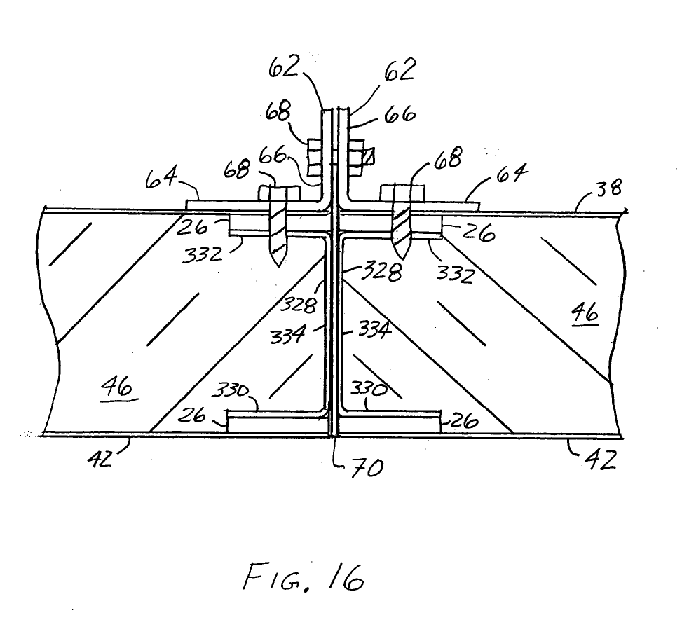

In an alternate embodiment of the construction shown in FIG. 13, FIG. 14 shows a panel framework including a layer of insulating material 56, such as fiberglass, inserted between skins 38, 42. In this construction, skin 42 contains through perforations (not shown) and a thin sheet of material, such as MYLAR®, a registered trademark of E.I. Du Pont De Nemours and Company, prevents fiberglass fibers from escaping into the airstream. Once the insulating material 56 layer is installed, a second insulating material 46, such as polyurethane foam, is injected into the assembled panel framework to fill the remaining portion of the chamber defined by the support member 328, insulating materials 56, 26 and skin 38. This construction, as shown in FIG. 14 is effective in muffling sound produced by components housed within the AHU.

FIG. 15, which is a partial cross section of a pair of panel frameworks forming a corner joint of an AHU, includes a structural member 62, such as an angle, having legs that are each in conformal contact with adjacent ends of skin 42 of each adjacent panel framework. To permit disassembly of the AHU, the legs of structural member 62 are preferably secured by removable fasteners 64 that each partially penetrate the panel framework, such as skin 42, insulating member 26 and leg 330 of structural member 328 and partially into insulating material 46. By virtue of the relatively shallow penetration of the fasteners 64 into the framework members, there is no continuous path of substantially reduced thermal insulative properties between skins 38, 42. To provide enhanced thermal insulation to the corner joint, a layer of flexible insulating material 60 can be adhered to the ends of the framework members. Although shown as a layer that can be bent to form an angle, insulating material 60 could be sized in block form to fill the entire area between ends of the adjacent transversely disposed pair of framework members, providing a uniform corner surface, such as a rounded region, chamfered region, or other profile, if desired.

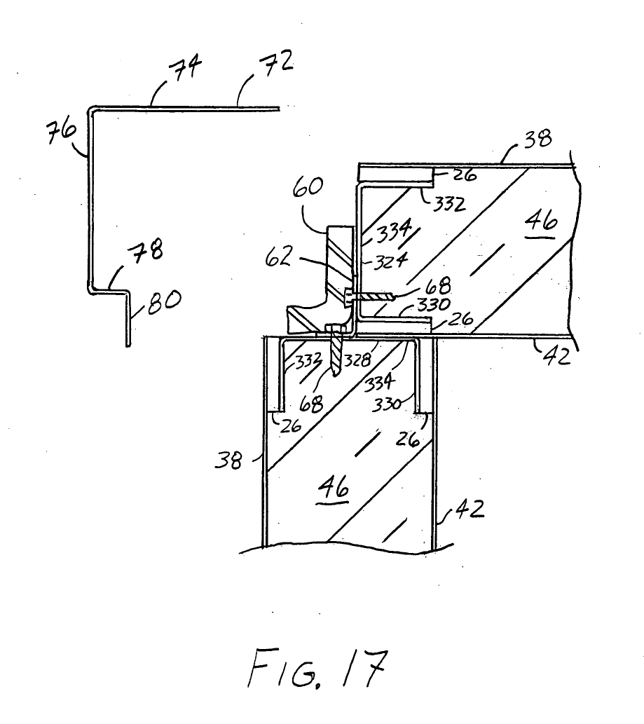

FIG. 16, which is a partial cross section of a pair of panel frameworks forming a butt joint, commonly referred to as a “split,” provides a means to join separate portions of the AHU, the primary reason for the separate portions to accommodate transportation, e.g., size and/or weight considerations. Disposed adjacent to each respective facing end of a panel framework is a structural member 62, such as an angle. Structural member 62 has a horizontal leg 64 that is in contact with skin 38 and secured to skin 38 by a fastener 68 and a vertical leg 66 that is substantially coincident with the end of the respective panel framework. In other words, the surface of vertical leg 62 facing away from horizontal leg 64 is substantially coincident with the surface of web 334 of support member 324 facing away from legs 330, 332. Preferably disposed between the ends of the adjacent panel frameworks is a gasket 70 composed of a resilient material having a high thermal insulation value. As shown, gasket 70 preferably extends from skin 42 to the base of the apertures formed in the vertical legs 66 for securing a removable fastener 68, such as a nut and bolt, that passes through the adjacent vertical legs 66. Upon actuation of one end of the fastener 68 in one direction with respect to the other, the nut is drawn toward the head of the bolt, drawing the adjacent vertical legs 66 toward each other, compressing the gasket 70 between both the vertical legs 66 and respective ends of the panel frameworks. Similar to the corner joint, there is no continuous path of substantially reduced thermal insulative properties between skins 38, 42.

FIG. 17 is a partial cross section of a pair of panel frameworks defining a peripheral roof joint for an AHU. In other words, the panel framework supported along the end of skin 42 by an adjacent transversely disposed panel framework forms the roof of the AHU. To secure the roof panel framework in position, a structural member 62, preferably an angle, contacts a portion of the respective webs 334 of each support member 324, with a fastener 68 extending through each web 334 and into the insulating material 46. Similar to the corner joint, a layer of insulating material 60 is preferably bonded over the fasteners 68 and at least portions of the ends of the panel frameworks as previously discussed. A corner cap 72 is then installed over the peripheral roof joint.

Cap 72 includes a pair of substantially perpendicular legs 74, 76 that define an angle, with a leg 78 extending from the end of leg 76 opposite leg 74 in a direction that is substantially perpendicular to leg 76. An additional leg 80 extends substantially perpendicular from the end of leg 78 that is opposite leg 76. When cap 72 is installed, preferably by adhesive, the end of leg 74 opposite the juncture of legs 74, 76 contacts skin 38 of the roof panel framework and leg 80 contacts skin 38 of the supporting panel framework. In this construction, leg 76 is substantially vertical, so that precipitation collecting on skin 38 of the roof panel framework will begin flowing, by virtue of gravity, along leg 76 toward the base of the AHU. To help deflect precipitation away from skin 38 of the supporting panel framework, which defines a vertical exterior wall of the AHU that is in contact with leg 80, leg 78 acts as a spacer to provide separation between skin 38 and leg 76. Preferably, the angle between legs 76 and 78 is acute, thereby providing an “edge” preventing condensation from flowing along leg 78 toward vertically disposed skin 38.

It is to be understood that mechanical fasteners can be constructed of non-metal fasteners, such as ribbed plastic fasteners. While the constructions disclosed may also be constructed of metal which are sufficient to prevent a continuous path of substantially reduced thermal insulative properties between skins of a panel, use of non-metal fasteners can provide further enhanced thermal insulative properties.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A panel construction for an air handling unit comprising:
a first skin;
a second skin; and
a plurality of members disposed between the first and second skin to separate the first and second skin, each member of the plurality of members being connectable to one or both the first and second skins and comprising:
at least one structural member;
at least one thermal break; and
wherein the at least one structural member and the at least one thermal break are configured and disposed to prevent a continuous path of substantially reduced thermal insulative properties between the first and second skin.

2. The panel of claim 1 wherein the first and second skin and the at least one structural member are metal.

3. The panel of claim 1 wherein the first and second skin and the plurality of members can be assembled without mechanical fasteners.

4. The panel of claim 1 wherein a second thermal break is injected inside a chamber defined by the first and second skin and the plurality of members, the second thermal break substantially filling the chamber.

5. The panel of claim 1 wherein the at least one thermal break is disposed between at least one of the at least one structural member and the first skin, and the at least one structural member and the second skin.

6. The panel of claim 1 wherein the second thermal break is polyurethane foam.

7. The panel of claim 1 wherein the at least one thermal break is a polymeric.

8. The panel of claim 7 wherein the polymeric is provided in discontinuous segments.

9. The panel of claim 1 wherein when the first and second skin and the plurality of members are pre-positioned, the first and second skin are movable with respect to each other and the plurality of members prior to assembly.

10. The panel of claim 1 wherein at least one connection between the plurality of members and the first and second skin is achieved with an adhesive.

11. The panel of claim 10 wherein the adhesive is applied to opposed surfaces of a tape.

12. The panel of claim 1 wherein at least one connection between the plurality of members and the first and second skin is achieved with a bonding agent.

13. The panel of claim 1 wherein the first skin includes a plurality of apertures, a thin sheet of material having two surfaces applied over one surface of the first skin facing the second skin, a layer of a second thermal break having opposite surfaces overlies the opposite surface of the sheet and a third thermal break is injected to fill the remaining portion of a chamber defined by the opposite surface of the second thermal break, the at least one support member, the at least one thermal break and the second skin.

14. A panel construction for an air handling unit comprising:
a first metal skin;
a second metal skin; and
a plurality of members disposed between the first and second skin to separate the first and second skin, each member of the plurality of members being connectable to one or both the first and second skins and comprising:
at least one metal structural member;
at least one thermal break; and
wherein the at least one structural member and the at least one thermal break are configured and disposed to prevent a continuous metal-to-metal contact between the first and second skin.

15. The panel of claim 14 wherein the first and second skin and the plurality of members can be assembled without mechanical fasteners.

16. The panel of claim 14 wherein a second thermal break is injected inside a chamber defined by the first and second skin and the plurality of members, the second thermal break substantially filling the chamber.

17. The panel of claim 14 wherein when the first and second skin and the plurality of members are pre-positioned, the first and second skin are movable with respect to each other and the plurality of members prior to assembly.

18. The panel of claim 14 wherein at least one connection between the plurality of members and the first and second skin is achieved with an adhesive.

19. The panel of claim 18 wherein the adhesive is applied to opposed surfaces of a tape.

20. The panel of claim 14 wherein at least one connection between the plurality of members and the first and second skin is achieved with a bonding agent.

21. A method of constructing a panel for an air handling unit, the steps comprising:
assembling a plurality of members, each member of the plurality of members comprising at least one structural member and at least one thermal break, wherein the at least one structural member and the at least one thermal break are configured and disposed to form opposed surfaces, there being an absence of a continuous path of substantially reduced thermal insulative properties between the opposed surfaces;
connecting a first skin to one surface;
connecting a second skin to the surface opposite the one surface; and
injecting an insulating material between the first and second skin.

22. The method of claim 21 wherein the step of assembling a plurality of members further includes the step of pre-positioning the first and second skins to the opposed surfaces.
